(19) United States
(12) Patent Application Publication
(10) Pub. No.: US 2025/0276213 A1
(43) Pub. Date: Sep. 4, 2025

(54) GOLF SWING ANALYSIS APPARATUS AND METHOD

(71) Applicant: Hyunjik BAE, Seongnam-si (KR)

(72) Inventor: Hyunjik BAE, Seongnam-si (KR)

(73) Assignee: Hyunjik BAE, Seongnam-si (KR)

(21) Appl. No.: 19/211,541

(22) Filed: May 19, 2025

Related U.S. Application Data
(63) Continuation of application No. PCT/KR2023/019580, filed on Nov. 30, 2023.

(30) Foreign Application Priority Data
Jan. 11, 2023 (KR) 10-2023-0003913

(51) Int. Cl. A63B 24/00; G06T 3/4038; G06T 7/70

(52) U.S. Cl. CPC A63B 24/0003; A63B 24/0021; G06T 3/4038; G06T 7/70; A63B 2024/0034; A63B 2024/0043; A63B 2220/807; G06T 2207/30224

(57) ABSTRACT

Disclosed are a golf swing analysis apparatus and a method thereof. The golf swing analysis apparatus includes an input unit including a first camera and a second camera, an image analysis unit that identifies first coordinate information corresponding to first image data obtained from the first camera, a calculation unit that identifies impact section data based on the first coordinate information, and an output unit that externally outputs ball flight information calculated by the calculation unit. The image analysis unit transmits, to the calculation unit, second image data obtained from the second camera corresponding to the impact section data. The calculation unit identifies the ball flight information about a practice swing of a user based on the impact section data and the second image data.

### CROSS-REFERENCE TO RELATED APPLICATIONS

The present application is a continuation of International Patent Application No. PCT/KR2023/019580, filed on Nov. 30, 2023, which is based upon and claims the benefit of priority to Korean Patent Application No. 10-2023-0003913 filed on Jan. 11, 2023. The disclosures of the above-listed applications are hereby incorporated by reference herein in their entirety.

### BACKGROUND

Embodiments of the present disclosure described herein relate to a golf swing analysis apparatus and a method thereof, and more particularly, relate to a golf swing analysis apparatus that analyzes a user's practice swing and provides the prediction result according to the practice swing, and a method thereof.

Nowadays, with the rapid increase in the golf population, various devices and methods are being proposed to improve the skills of golfers, such as golf practice machines, golf simulations, golf swing guides, golf swing correction devices, weight shift readers, and putting practice mats. Among them, a golf swing analysis apparatus helps both beginner and professional golfers to practice and master the correct swing to improve their skills.

A conventional golf swing analysis apparatus has been implemented by measuring the movement of a club head by using a halogen light attached to the ceiling, an external computer, and an infrared sensor. However, such the golf swing analysis apparatus has disadvantages in installation, storage, and movement in that it requires two or more rows of light sensors to detect light on the bottom surface where a golf ball is struck, it is difficult to use in brightness above a certain level of illumination, and halogen lights needs to be moved when the golf swing analysis apparatus moves.

In the meantime, another conventional golf swing analysis apparatus has been implemented by using proximity sensors arranged on the floor. As such, the golf swing analysis apparatus has the disadvantages in that a large number of proximity sensors need to be used to more accurately identify a club's movement path, the cost of proximity sensors is higher than that of optical sensors, and high current consumption makes it difficult to use it for mobile purposes.

### SUMMARY

Embodiments of the present disclosure provide a golf swing analysis apparatus for analyzing a user's practice swing and providing a prediction result according to the practice swing, and a method thereof.

Embodiments of the present disclosure provide a golf swing analysis apparatus for providing swing prediction results obtained by reflecting surrounding environment information, and a method thereof.

Embodiments of the present disclosure provide a golf swing analysis apparatus that is portable and attachable.

Problems to be solved by the present disclosure are not limited to the problems mentioned above, and other problems not mentioned will be clearly understood by those skilled in the art from the following description.

According to an embodiment, a golf swing analysis apparatus includes an input unit including a first camera and a second camera, an image analysis unit that identifies first coordinate information corresponding to first image data obtained from the first camera, a calculation unit that identifies impact section data based on the first coordinate information, and an output unit that externally outputs ball flight information calculated by the calculation unit. The image analysis unit transmits, to the calculation unit, second image data obtained from the second camera corresponding to the impact section data. The calculation unit calculates ball flight information about a practice swing of a user based on the impact section data and the second image data. The first coordinate information includes center coordinate information of a golf ball, radius information of the golf ball, and center coordinate information of a club head adjacent to the golf ball. The impact section data includes image data at a moment when the club head passes in front of the golf ball. The calculation unit calculates the ball flight information based on the center coordinate information of the club head and club head angle information formed by a face surface of the club head and a ground on which the golf ball is placed. The second image data obtained from the second camera has higher resolution than the first image data obtained from the first camera. The image analysis unit identifies the first coordinate information based on the first image data. The image analysis unit extracts partial image data corresponding to the club head from the second image data based on the first coordinate information. The calculation unit identifies the club head angle information based on the extracted partial image data.

According to an embodiment, a golf swing analysis system includes a golf swing analysis apparatus that identifies ball flight information about a practice swing of a user, a server that obtains first image data, first coordinate information, impact section data, and ball flight information from the golf swing analysis apparatus, and generates image data based on the first image data, the first coordinate information, the impact section data, and the ball flight information, and a user terminal that outputs the image data obtained from the server. The golf swing analysis apparatus includes an input unit including a first camera and a second camera, an image analysis unit that identifies first coordinate information corresponding to first image data obtained from the first camera, a calculation unit that identifies impact section data based on the first coordinate information, and an output unit that externally outputs ball flight information calculated by the calculation unit. The image analysis unit transmits, to the calculation unit, second image data obtained from the second camera corresponding to the impact section data. The calculation unit calculates ball flight information about the practice swing of the user based on the impact section data and the second image data. The first coordinate information includes center coordinate information of a golf ball, radius information of the golf ball, and center coordinate information of a club head adjacent to the golf ball. The impact section data includes image data at a moment when the club head passes in front of the golf ball. The calculation unit calculates the ball flight information based on the center coordinate information of the club head and club head angle information formed by a face surface of the club head and a ground on which the golf ball is placed. The second image data obtained from the second camera has higher resolution than the first image data obtained from the first camera. The image analysis unit identifies the first coordinate information based on the first image data. The image analysis unit extracts partial image data corresponding to the club head from the second image data based on the first coordinate information. The calculation unit identifies the club head angle information based on the extracted partial image data.

According to an embodiment, a method performed by a golf swing analysis apparatus includes obtaining first image data from a first camera of the golf swing analysis apparatus, obtaining second image data from a second camera of the golf swing analysis apparatus, identifying first coordinate information corresponding to the first image data, identifying impact section data based on the first coordinate information, obtaining the second image data corresponding to the impact section data, calculating ball flight information about a practice swing of a user based on the impact section data and the second image data, and externally outputting the ball flight information. The first coordinate information includes center coordinate information of a golf ball, radius information of the golf ball, and center coordinate information of a club head adjacent to the golf ball. The impact section data includes image data at a moment when the club head passes in front of the golf ball. The golf swing analysis apparatus calculates the ball flight information based on the center coordinate information of the club head and club head angle information formed by a face surface of the club head and a ground on which the golf ball is placed. The second image data obtained from the second camera has higher resolution than the first image data obtained from the first camera. The golf swing analysis apparatus identifies the first coordinate information based on the first image data, extracts partial image data corresponding to the club head from the second image data based on the first coordinate information, and identifies the club head angle information based on the extracted partial image data.

Besides, a computer program stored in a computer-readable recording medium for execution to implement the present disclosure may be further provided.

In addition, a computer-readable recording medium for recording a computer program for performing the method for implementing the present disclosure may be further provided.

### BRIEF DESCRIPTION OF THE FIGURES

The above and other objects and features will become apparent from the following description with reference to the following figures, wherein like reference numerals refer to like parts throughout the various figures unless otherwise specified, and wherein:

FIGS. 1A and 1B are block diagrams illustrating a schematic configuration of a golf swing analysis apparatus, according to an embodiment of the present disclosure;

FIG. 2 is a flowchart for describing a golf swing analysis method, according to an embodiment of the present disclosure;

FIG. 3 is a drawing for describing image data obtained according to an embodiment of the present disclosure;

FIG. 4 is a diagram for describing an image data analysis method, according to an embodiment of the present disclosure;

FIG. 5 is a diagram for describing a method for collecting an impact section, according to an embodiment of the present disclosure;

FIG. 6 is a drawing for describing a ball flight calculation method, according to an embodiment of the present disclosure;

FIG. 7 is a diagram for describing a golf swing analysis method, according to another embodiment of the present disclosure;

FIG. 8 is a drawing for describing a usage form of a golf swing analysis apparatus, according to an embodiment of the present disclosure; and

FIG. 9 is a diagram illustrating a schematic configuration of a golf swing analysis system, according to an embodiment of the present disclosure.

### DETAILED DESCRIPTION

The same reference numerals denote the same elements throughout the present disclosure. The present disclosure does not describe all elements of embodiments. Well-known content in a technical field, to which the present disclosure belongs, or redundant content in which embodiments are the same as one another will be omitted. A term such as ‘unit, module, member, or block’ used in the specification may be implemented with software or hardware. According to embodiments, a plurality of ‘units, modules, members, or blocks’ may be implemented with one component, or a single ‘unit, module, member, or block’ may include a plurality of components.

Throughout this specification, when it is supposed that a portion is “connected” to another portion, this includes not only a direct connection, but also an indirect connection. The indirect connection includes being connected through a wireless communication network.

Furthermore, when a portion “comprises” a component, it will be understood that it may further include another component, without excluding other components unless specifically stated otherwise.

Throughout this specification, when it is supposed that a member is located on another member “on”, this includes not only the case where one member is in contact with another member but also the case where another member is present between two other members.

Terms such as ‘first’, ‘second’, and the like are used to distinguish one component from another component, and thus the component is not limited by the terms described above.

Unless there are obvious exceptions in the context, a singular form includes a plural form.

In each step, an identification code is used for convenience of description. The identification code does not describe the order of each step. Unless the context clearly states a specific order, each step may be performed differently from the specified order.

Hereinafter, operating principles and embodiments of the present disclosure will be described with reference to the accompanying drawings.

In this specification, an ‘apparatus according to an embodiment of the present disclosure’ includes all various devices capable of providing results to a user by performing arithmetic processing. For example, the apparatus according to an embodiment of the present disclosure may include all of a computer, a server device, and a portable terminal, or may be in any one form.

Here, for example, the computer may include a notebook computer, a desktop computer, a laptop computer, a tablet PC, a slate PC, and the like, which are equipped with a web browser.

The server device may be a server that processes information by communicating with an external device and may include an application server, a computing server, a database server, a file server, a game server, a mail server, a proxy server, and a web server.

For example, the portable terminal may be a wireless communication device that guarantees portability and mobility, and may include all kinds of handheld-based wireless communication devices such as a smartphone, a personal communication system (PCS), a global system for mobile communication (GSM), a personal digital cellular (PDC), a personal handyphone system (PHS), a personal digital assistant (PDA), International Mobile Telecommunication (IMT)-2000, a code division multiple access (CDMA)-2000, W-Code Division Multiple Access (W-CDMA), and Wireless Broadband Internet (WiBro) terminal, and a wearable device such as a timepiece, a ring, a bracelet, an anklet, a necklace, glasses, a contact lens, or a head-mounted device (HMD).

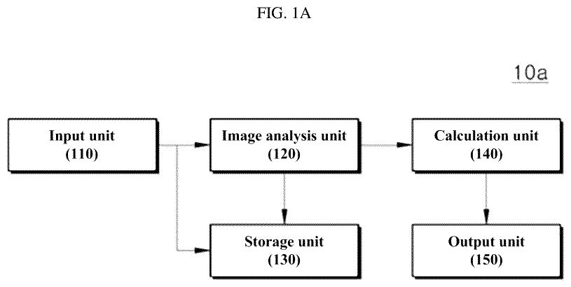

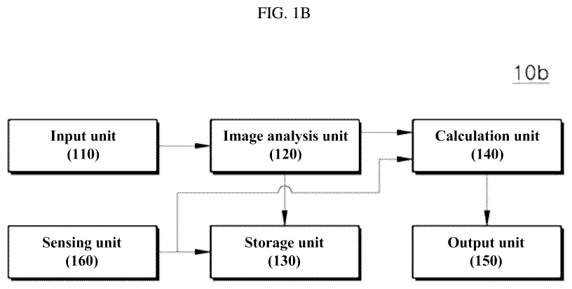

FIGS. 1A and 1B are block diagrams illustrating a schematic configuration of a golf swing analysis apparatus 10a or 10b, according to an embodiment of the present disclosure.

FIG. 1A illustrates a schematic configuration of the golf swing analysis apparatus 10a, according to an embodiment of the present disclosure. Referring to FIG. 1A, the golf swing analysis apparatus 10a according to an embodiment of the present disclosure may include an input unit 110, an image analysis unit 120, a storage unit 130, a calculation unit 140, and an output unit 150.

The input unit 110 according to an embodiment of the present disclosure may include at least one camera and may acquire image data from the at least one camera. The at least one camera may process an image frame such as a still image or a video, which is obtained by an image sensor in a shooting mode. In the meantime, when there are a plurality of cameras, the plurality of cameras may be placed to form a matrix structure. In this way, pieces of image data having various angles or focuses may be input through the cameras forming the matrix structure. Furthermore, the plurality of cameras may be placed in a stereo structure to obtain left and right images for implementing a three-dimensional stereoscopic image. At least one image data acquired from the input unit 110 may be transmitted to at least one of the image analysis unit 120 and the storage unit 130.

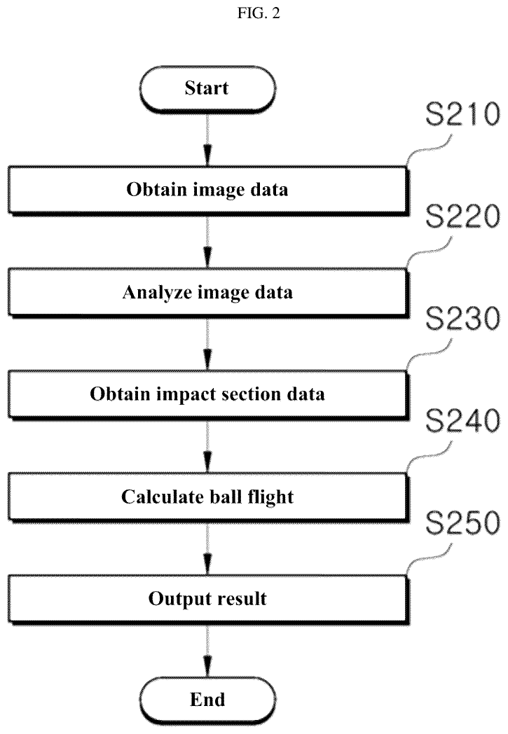

The image analysis unit 120 according to an embodiment of the present disclosure may analyze at least one image data obtained from the input unit 110. The image analysis unit 120 may identify coordinate information about at least one piece of image data and may transmit the identified coordinate information to the storage unit 130 and the calculation unit 140. The specific operation of the image analysis unit 120 is described in detail with reference to FIGS. 2 to 4.

In the meantime, the storage unit 130 according to an embodiment of the present disclosure may store at least part of at least one piece of image data obtained from the input unit 110, and merged image data generated from the image analysis unit 120. Moreover, the storage unit 130 may store data supporting various functions of the golf swing analysis apparatus 10a according to an embodiment of the present disclosure, and a program for an operation of the golf swing analysis apparatus 10a, and may also store input/output data. Furthermore, the storage unit 130 may store a plurality of application programs (or applications) running in the golf swing analysis apparatus 10a according to an embodiment of the present disclosure, pieces of data for an operation of the golf swing analysis apparatus 10a, and instructions for an operation of the golf swing analysis apparatus 10a. At least part of the application programs may be downloaded from an external server through wireless communication.

In an embodiment of the present disclosure, the storage unit 130 may include the type of a storage medium of at least one of a flash memory type, hard disk type, a solid state disk (SSD) type, a silicon disk drive (SDD) type, a multimedia card micro type, a memory of a card type (e.g., SD memory, XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disc. Furthermore, the storage unit 130 may be separate from the present device, but may be a database connected by wire or wirelessly.

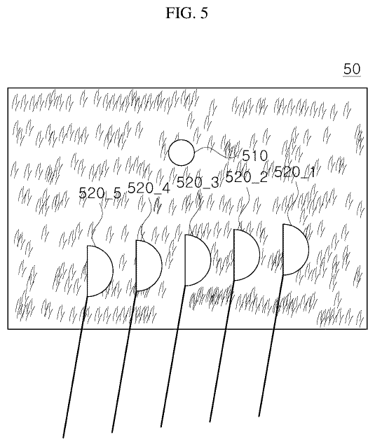

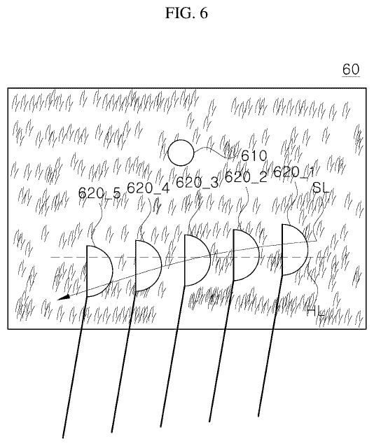

The calculation unit 140 may identify an impact section for calculating ball flight for a user's practice swing based on coordinate information obtained from the image analysis unit 120, and may calculate the ball flight of the practice swing performed by the user based on the identified impact section data. The calculation unit 140 may identify the ball flight of the user's practice swing through a first recognition operation and a second recognition operation, and specific operations related thereto are described in detail with reference to FIG. 5 and FIG. 6 described below.

The output unit 150 may output ball flight information of the user's practice swing identified from the calculation unit 140 to the outside. The output unit 150 according to an embodiment of the present disclosure may be a configuration for generating an output related to hearing, vision, or tactile sensations, and may include an audio output module. The audio output module may output an audio signal related to ball flight information identified from the calculation unit 140. In an embodiment, the sound output module may include a receiver, a speaker, a buzzer, or the like. In detail, when the ball flight of the user's practice swing is identified as a slice ball flight, the output unit 150 may output an audio signal of “when you hit it like now, you will get a slice.” Moreover, the golf swing analysis apparatus 10a according to an embodiment of the present disclosure may analyze a practice swing using a putter in addition to a driver, a wood, a utility, and an iron. When the head speed of the putter is determined to be low when a practice swing using a putter is analyzed, the output unit 150 may output an audio signal of “when you putt like now, a golf ball will roll by ‘N’ steps”, or “when you putt like now, the golf ball will roll by ‘X’ meters”.

In the meantime, in some embodiments, the output unit 150 may be connected to a display module separate from the golf swing analysis apparatus 10a. In this case, the output unit 150 may transmit visualization information related to ball flight information of the user's practice swing, which is identified from the calculation unit 140, to a display module. The display module may be included in a separate device linked to the golf swing analysis apparatus 10a, or may be included in the user's mobile phone, smart watch, wearable device, or tablet PC.

Alternatively, in some embodiments, the output unit 150 may include a haptic module. The haptic module may generate various tactile effects that the user is capable of feeling, and a representative example of a tactile effect generated by the haptic module is vibration. The intensity and pattern of vibration generated from the haptic module may be determined by the user's selection or settings for the golf swing analysis apparatus 10a. Furthermore, in addition to the vibration, the haptic module may generate various tactile effects such as an effect of stimulation of a pin arrangement that vertically moves on a contact skin surface, blowing force or suction force of air through a nozzle or suction port, rubbing against a skin surface, a contact of an electrode, electrostatic force, or the like, or an effect by the coolness and warmth generated by using elements capable of absorbing heat or generating heat. The haptic module may not only deliver a tactile effect through a direct contact, and may but also be implemented such that the user is capable of feeling a tactile effect through a muscle sense of a finger or arm. The two or more haptic modules may be provided depending on a configuration aspect of the present device.

For example, when the output unit 150 includes the haptic module and the ball flight of the user's practice swing is identified as a slice ball flight, the output unit 150 may generate a single vibration. Meanwhile, when the ball flight of the user's practice swing is identified as a hook ball flight, the output unit 150 may generate two vibrations. For another example, the output unit 150 may output results based on differently set vibration durations corresponding to ball flight information obtained from the calculation unit 140.

In the meantime, although not shown in FIG. 1A, the golf swing analysis apparatus 10a according to an embodiment of the present disclosure may further include a processor, a communication unit, and an interface unit. The processor may control operations of components included in the golf swing analysis apparatus 10a according to an embodiment of the present disclosure. The communication unit may include one or more components capable of communicating with an external device, and may include, for example, at least one of a broadcast reception module, a wired communication module, a wireless communication module, and a short-range communication module. The interface unit may serve as a passageway for various types of external devices connected to the golf swing analysis apparatus 10a according to an embodiment of the present disclosure. In an embodiment, the interface unit may include at least one of a wired/wireless headset port, an external charger port, a wired/wireless data port, a memory card port, a port for connecting a device equipped with a subscriber identification module (SIM), an audio input/output (I/O) port, a video I/O port, and an earphone port.

FIG. 1B illustrates a schematic configuration of a golf swing analysis apparatus 10b, according to another embodiment of the present disclosure. Referring to FIG. 1B, the golf swing analysis apparatus 10b according to another embodiment of the present disclosure includes the input unit 110, the image analysis unit 120, the storage unit 130, the calculation unit 140 and the output unit 150 similarly to the golf swing analysis apparatus 10a illustrated in FIG. 1A, but may further include a sensing unit 160. The input unit 110, the image analysis unit 120, the storage unit 130, the calculation unit 140, and the output unit 150 included in the golf swing analysis apparatus 10b illustrated in FIG. 1B may perform the same functions and operations as the input unit 110, the image analysis unit 120, the storage unit 130, the calculation unit 140, and the output unit 150 in FIG. 1A described above.

The sensing unit 160 included in the golf swing analysis apparatus 10b illustrated in FIG. 1B may sense at least one of internal information, surrounding environment information, and user information of the golf swing analysis apparatus 10b, and may generate a sensing signal corresponding thereto. The signal sensed from the sensing unit 160 may be stored in the storage unit 130 and may be delivered to the calculation unit 140 to be reflected in the calculation of the ball flight of the user's practice swing. For example, the sensing unit 160 may include at least one of a proximity sensor, an illumination sensor, a touch sensor, an acceleration sensor, a magnetic sensor, a G-sensor, a gyroscope sensor, a motion sensor, an RGB sensor, an infrared sensor (IR sensor), a finger scan sensor, an ultrasonic sensor, an optical sensor (e.g., a camera), a microphone, an environmental sensor (e.g., including at least one of a barometer, a hygrometer, a thermometer, a radiation detection sensor, a heat detection sensor, and a gas detection sensor), and a chemical sensor (e.g., a healthcare sensor, a biometric sensor, or the like). In the meantime, the present device may combine and utilize pieces of information sensed by at least two or more of these sensors.

The golf swing analysis apparatus 10a or 10b according to an embodiment of the present disclosure may analyze the user's practice swing and provides a prediction result according to the practice swing, thereby helping the user perform additional practice swings or perform aiming adjustments by analyzing the user's practice swing.

Moreover, the golf swing analysis apparatus 10a or 10b according to an embodiment of the present disclosure may provide a swing prediction result obtained by reflecting surrounding environment information such as surrounding terrain information and weather information, thereby allowing a user to swing to a more accurate target point compared to a case where the user performs an actual swing.

Furthermore, the golf swing analysis apparatus 10a or 10b according to an embodiment of the present disclosure may be implemented in a form capable of being attached to the user's glasses, hat, or headband, it may be easily carried not only to a practice range but also to a field, and ball flight information may be identified through a two-step recognition operation, thereby reducing the amount of computation for swing analysis and increasing the battery usage time.

FIG. 2 is a flowchart for describing a golf swing analysis method, according to an embodiment of the present disclosure.

In operation S210, a golf swing analysis apparatus 10a (see FIG. 1A) according to an embodiment of the present disclosure may obtain image data through the input unit 110 (see FIG. 1A). The input unit 110 according to an embodiment of the present disclosure may include at least one camera for obtaining the image data. For example, when the input unit 110 includes a single camera, the corresponding camera may have the resolution of 1300×1300 and a frame rate of 200 fps, may process the image data in black and white, and may have a low exposure setting to prevent blurring.

In the meantime, as another example, when the input unit 110 includes two cameras, the first camera may be a low-resolution camera and the second camera may be a high-resolution camera based on the predetermined resolution in the golf swing analysis apparatus 10a. For example, the first camera may have the resolution of 400×400 and a frame rate of 200 fps, may process image data in black and white, and may have low exposure settings. In the meantime, the second camera may have the resolution of 1300×1300 and a frame rate of 200 fps, may process image data in black and white, and may have low exposure settings. In this case, the first camera and the second camera may continue simultaneous recording. The first camera may recognize image data of all moments. On the other hand, the second camera may recognize image data of selective moments to reduce storage capacity. In detail, when an impact section is identified by the first camera, the second camera may recognize only image data in the impact section. The input unit 110 according to an embodiment of the present disclosure may obtain an image of the front of a golfer's head (i.e., near the line of sight) as data through at least one camera included in the input unit 110.

In operation S220, the golf swing analysis apparatus 10a (see FIG. 1A) according to an embodiment of the present disclosure transmits image data obtained from the input unit 110 to the image analysis unit 120 (see FIG. 1A), and the image analysis unit 120 may analyze the obtained image data. In detail, the image analysis unit 120 may obtain coordinate information based on the obtained image data, or may merge pieces of image data obtained from the input unit 110 and may obtain coordinate information about the merged image.

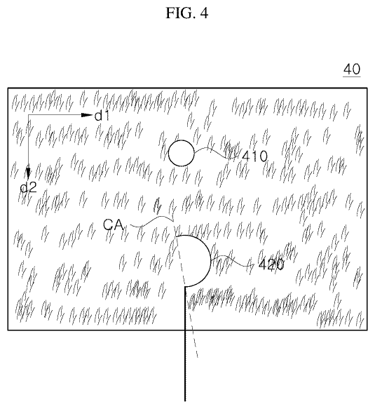

The coordinate information about image data obtained in operation S220 may be transmitted to the calculation unit 140 (see FIG. 1A). The specific operation of identifying coordinate information from image data is described in detail through FIG. 4 below.

In operation S230, the calculation unit 140 according to an embodiment of the present disclosure may obtain impact section data for calculating ball flight for a user's practice swing based on the coordinate information obtained from the image analysis unit 120. In an embodiment, the impact section data may refer to image data list at the moment when the user's club head passes in front of or near a golf ball placed on the ground, and may be identified based on the coordinate information of the club head. The specific operation for identifying impact section data is described in detail with reference to FIG. 5 below.

In operation S240, the calculation unit 140 according to an embodiment of the present disclosure may calculate a predicted ball flight for the user's practice swing based on the impact section data obtained in operation S230. The predicted ball flight for the user's practice swing may be determined from a predicted flight speed, a predicted direction, and a side spin, which are derived from an orbit in which a club head relatively passes relative to the golf ball placed on the ground, an edge angle of the club head, and the speed at which the club head passes. The specific operation of calculating the predicted ball flight for the user's practice swing is described in detail with reference to FIG. 6 below.

In operation S250, the output unit 150 (see FIG. 1A) according to an embodiment of the present disclosure may output predicted ball flight information about the user's practice swing identified from the calculation unit 140 to the outside.

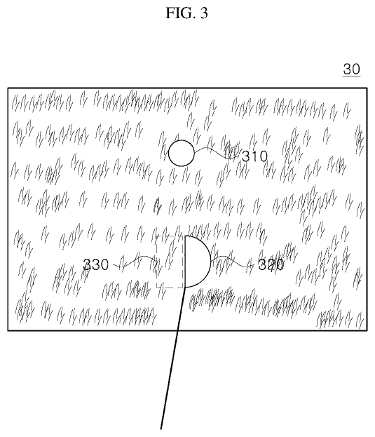

FIG. 3 is a drawing for describing image data 30 obtained according to an embodiment of the present disclosure. The image data 30 illustrated in FIG. 3 may be obtained from at least one camera included in the input unit 110 included in the golf swing analysis apparatus 10a according to an embodiment of the present disclosure, and may include information about a golf ball 310 placed on the ground and a club head 320 set up by a user.

When the user performs a practice swing, the user does not actually hit the golf ball 310 placed on the ground, but performs the practice swing by placing the club head 320 in a space 330 in front of the golf ball 310. The input unit 110 may obtain image data of the front of the user's head (i.e., near the line of sight) and image data obtained by the input unit 110 may be stored in the storage unit 130 (see FIG. 1A). When the image data is not related to impact section data, the image data may be deleted after a specific period.

FIG. 4 is a diagram for describing an image data analysis method, according to an embodiment of the present disclosure. FIG. 4 illustrates image data 40 transmitted from the input unit 110 (see FIG. 1A) to the image analysis unit 120 (see FIG. 1A), and the image analysis unit 120 may identify coordinate information about the image data 40 obtained from the input unit 110.

In detail, coordinate information identified according to an embodiment of the present disclosure may include at least some of center position information of a golf ball 410, radius information of the golf ball 410, center position information of a club head 420, and angle information of the club head 420. The center position information of the golf ball 410 may be identified as two-dimensional (2D) coordinate information about a first reference point set for the image data 40. The radius information of the golf ball 410 may be identified as scalar value information corresponding to a straight-line distance from the center position of the golf ball 410 to the outer surface of the golf ball 410.

Moreover, the center position information of the club head 420 may also be identified as 2D coordinate information about a second reference point set for the face of the club head 420. The angle information of the club head 420 may be identified as angle information CA of the face surface of the club head 420 relative to the ground, which is obtained by reflecting the loft angle of the club head.

In the meantime, coordinate information that is not recognized from the image data 40 may be recognized as null. In some embodiments, coordinate information through the image analysis unit 120 may be identified based on machine learning and, in particular, may be identified based on YOLO-X-based machine learning and other known image recognition techniques.

In the meantime, when a plurality of cameras are included in the input unit 110, the image analysis unit 120 may perform a two-step image analysis process. The image analysis unit 120 may perform first image recognition based on low-resolution image data obtained from the first camera.

In particular, the image analysis unit 120 may generate merged image data by merging low-resolution image data obtained from the first camera into specific units (e.g., 5 frames).

The merging of image data may be performed by averaging pixel values of pieces of image data. When the merged image data is generated, the image analysis unit 120 may identify the coordinate information about the merged image data, not coordinate information about individual image data.

When coordinate identification is performed on the merged image data, the amount of computation for image recognition may be reduced, and coordinate information may be identified based on low-resolution image data, thereby reducing the amount of computation according to resolution.

However, to calculate the angle information of the club head 420, there are limitations in using low-resolution image data, and thus, in some embodiments, the angle information of the club head 420 may be performed in a second image recognition step of using high-resolution image data.

In the meantime, the merged image data generated from the image analysis unit 120 is transmitted to the calculation unit 140 (see FIG. 1A), and the second image recognition may be performed based on the high-resolution image data obtained from the second camera based on the impact section data identified from the calculation unit 140.

In detail, the high-resolution image data corresponding to impact section data identified based on merged image data may be extracted, and the extracted high-resolution image data may be transmitted from the image analysis unit 120 to the calculation unit 140.

Alternatively, the image analysis unit 120 may extract a portion of the high-resolution image data based on coordinate information identified based on the merged image data. In this case, a portion of the extracted high-resolution image data may be partial image data corresponding to a club head included in the high-resolution image data.

In an embodiment, the calculation unit 140 may identify accurate club head angle information and club head center coordinate information based on the partial image data.

FIG. 5 is a diagram for describing a method for collecting an impact section, according to an embodiment of the present disclosure. In particular, impact section data 50 according to an embodiment of the present disclosure may include pieces of data 520_1 to 520_5 from the first data 520_1 of the moment when a club head first appears to the fifth data 520_5 of the moment when the club head disappears from a camera included in the input unit 110 (see FIG. 1A), in consideration of a direction of the club head based on a golf ball 510 placed on the ground.

In detail, when a user is a right-handed hitter, the impact section data 50 may include the second to fifth data 520_2 to 520_5 in which an x-axis coordinate value corresponding to the center coordinate information of the club head decreases based on the first data 520_1 as the impact section data 50. When the user is a left-handed hitter, the impact section data may include data in which the x-axis coordinate value corresponding to the center coordinate information of the club head increases as the impact section data 50.

FIG. 6 is a drawing for describing a ball flight calculation method, according to an embodiment of the present disclosure. On the basis of impact section data 60 illustrated in FIG. 6, the calculation unit 140 (FIG. 1A) according to an embodiment of the present disclosure may identify ball flight information about a user's practice swing based on the user's club head orbit SL and coordinate information obtained from image data.

The calculation unit 140 according to an embodiment of the present disclosure may calculate center coordinates of a club head, may identify the club head orbit SL through the movement trajectory of the corresponding coordinates, and may identify ball flight information about the user's practice swing based on the club head orbit SL. For example, the club head orbit SL may be identified as an out-in orbit compared to a vertical horizontal line HL corresponding to a golf ball 160 placed on the ground. In this case, the ball flight information about the user's practice swing may be identified as a fade ball flight.

In the meantime, when the club head orbit SL is identified as an in-out orbit relative to the vertical horizontal line HL, the ball flight information about the user's practice swing may be identified as a hook ball flight.

In an embodiment of the present disclosure, the calculation unit 140 may perform machine learning to identify ball flight information about the user's practice swing. The machine learning model used in an embodiment may utilize existing network models such as reinforcement learning and RNN. A plurality of golfers may perform actual hitting, and learning may be performed based on the data obtained from the performed result.

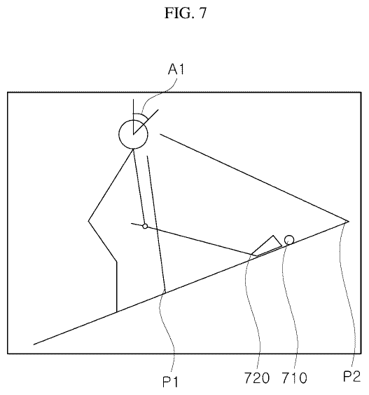

FIG. 7 is a diagram for describing a golf swing analysis method, according to another embodiment of the present disclosure. In particular, when the golf swing analysis method illustrated in FIG. 7 includes the sensing unit 160 (see FIG. 1B) like the golf swing analysis apparatus 10b (see FIG. 1B) illustrated in FIG. 1B described above, FIG. 7 is a drawing for describing a golf swing analysis method performed by the golf swing analysis apparatus 10b.

In an embodiment of the present disclosure, the golf swing analysis apparatus 10b including the sensing unit 160 may measure natural environment information such as a slope with respect to the ground of a user, airflow volume, a wind direction, and precipitation obtained through the sensing unit 160 and may reflect the measured information in calculating the user's ball flight information.

In particular, when the sensing unit 160 includes a gyroscope sensor, the golf swing analysis apparatus 10b may reflect the user's inclination with respect to the ground based on angle information A1 obtained from the gyroscope sensor in calculating the user's ball flight information.

The golf swing analysis apparatus 10b may obtain first location information corresponding to a golf ball 710 and second location information corresponding to a user's club head 720, may obtain the user's field-of-view information P1 to P2 based on the first location information and the second location information, and may identify ball flight information about the user's practice swing based on at least some of the angle information A1, the first location information, the second location information, and the user's field-of-view information P1 to P2.

For example, when the user performs a normal swing on an uphill slope as illustrated in FIG. 7, the ball flight information about the user's practice swing may be identified as a hook ball flight. In other words, ball flight information about the user's practice swing may be identified by synthesizing the signal information acquired from the sensing unit 160 and the analysis results for the user's practice swing.

In an embodiment, the sensing unit 160 may further include at least one sensor for measuring various pieces of natural environment information. In this case, the sensing unit 160 may additionally identify ball flight information about the user's practice swing by reflecting signal information obtained from the at least one sensor.

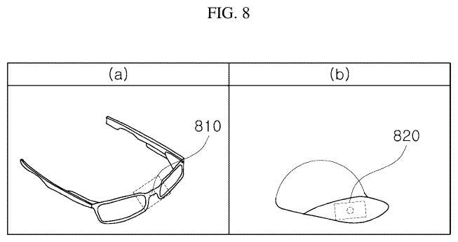

FIG. 8 is a drawing for describing a usage form of the golf swing analysis apparatus 10a or 10b (see FIGS. 1A and 1B), according to an embodiment of the present disclosure.

Referring to FIG. 8, as in the first embodiment (a), the golf swing analysis apparatus 10a or 10b according to an embodiment of the present disclosure may be used while being attached to glasses, goggles, sunglasses, or the like, which are worn by a user.

Alternatively, as in the second embodiment (b), the golf swing analysis apparatus 10a or 10b according to an embodiment of the present disclosure may be used while being attached to a hat or the like worn by the user. For example, the golf swing analysis apparatus 10a or 10b may be manufactured in a clip type or a magnetic type. The usage form of the golf swing analysis apparatus 10a or 10b according to an embodiment of the present disclosure may have various forms in addition to the example disclosed in FIG. 8.

Furthermore, the golf swing analysis apparatus 10a or 10b according to an embodiment of the present disclosure may be manufactured in various attachment types for easy portability of users.

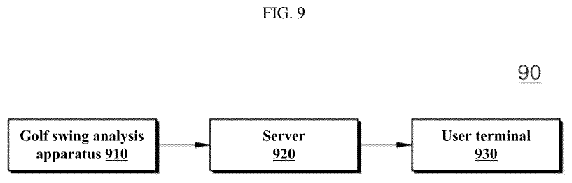

FIG. 9 is a diagram illustrating a schematic configuration of a golf swing analysis system 90, according to an embodiment of the present disclosure. Referring to FIG. 9, the golf swing analysis system 90 according to an embodiment of the present disclosure may include a golf swing analysis apparatus 910, a server 920, and a user terminal 930.

The golf swing analysis apparatus 910 may be any one of the golf swing analysis apparatuses 10a and 10b (see FIGS. 1A and 1B) disclosed in FIGS. 1A and 1B described above, and the server 920 may operate in conjunction with the golf swing analysis apparatus 910. In some embodiments, the golf swing analysis apparatus 910 may transmit data, which is derived through FIGS. 2 to 7, to the server 920.

The data transmitted to the server 920 may include at least part of first image data obtained from a first camera, first coordinate information identified from the first image data, impact section data, second image data obtained from a second camera, and ball flight information about a user's practice swing identified from the second image data. The server 920 may store data obtained from the golf swing analysis apparatus 910 in a database within the server 920.

Moreover, the server 920 may transmit, to the user terminal 930, golf swing data derived based on data obtained from the golf swing analysis apparatus 910. In an embodiment, the golf swing data may refer to data that visually represents the ball flight results for the user's practice swing analyzed by using the golf swing analysis apparatus 910, and may be generated as two-dimensional or three-dimensional image data.

Alternatively, in some embodiments, the golf swing data may be image or video data for implementing at least one of Augmented Reality (AR), Virtual Reality (VR), and Mixed Reality (MR). Alternatively, in some embodiments, the golf swing data may further include various pieces of numerical data related to the user's practice swing. In an embodiment, the user terminal 930 may be at least one of the user's mobile phone, tablet PC, laptop, smart watch, and smart device.

Meanwhile, the disclosed embodiments may be implemented in a form of a recording medium storing instructions executable by a computer. The instructions may be stored in a form of program codes, and, when executed by a processor, generate a program module to perform operations of the disclosed embodiments. The recording medium may be implemented as a computer-readable recording medium.

The computer-readable recording medium may include all kinds of recording media in which instructions capable of being decoded by a computer are stored. For example, there may be read only memory (ROM), random access memory (RAM), magnetic tape, magnetic disk, flash memory, optical data storage device, and the like.

Disclosed embodiments are described above with reference to the accompanying drawings. One ordinary skilled in the art to which the present disclosure belongs will understand that the present disclosure may be practiced in forms other than the disclosed embodiments without altering the technical ideas or essential features of the present disclosure. The disclosed embodiments are examples and should not be construed as limited thereto.

According to the above-mentioned problem solving means of the present disclosure, the present disclosure may analyze a user's practice swing to provide predicted ball flight information such that a user performs additional practice swings or performs aiming adjustments.

According to the above-mentioned problem solving means of the present disclosure, the present disclosure may provide a swing prediction result obtained by reflecting surrounding environment information such as surrounding terrain information and weather information, thereby helping the user swing to a more accurate target point.

According to the above-mentioned problem solving means of the present disclosure, the present disclosure may provide a golf swing analysis apparatus that is portable not only in a practice range but also in a field.

Moreover, according to the above-mentioned problem solving means of the present disclosure, the present disclosure may identify ball flight information through a two-step recognition operation, thereby reducing the amount of computation for swing analysis and increasing battery usage time.

While the present disclosure has been described with reference to embodiments, it will be apparent to those skilled in the art that various changes and modifications may be made without departing from the spirit and scope of the present disclosure. Therefore, it should be understood that the above embodiments are not limiting, but illustrative.

What is claimed is:

1. A golf swing analysis apparatus, the apparatus comprising:
an input unit including a first camera and a second camera;
an image analysis unit configured to identify first coordinate information corresponding to first image data obtained from the first camera;
a calculation unit configured to identify impact section data based on the first coordinate information; and
an output unit configured to externally output ball flight information calculated by the calculation unit,
wherein the image analysis unit transmits, to the calculation unit, second image data obtained from the second camera corresponding to the impact section data,
wherein the calculation unit calculates ball flight information about a practice swing of a user based on the impact section data and the second image data,
wherein the first coordinate information includes center coordinate information of a golf ball, radius information of the golf ball, and center coordinate information of a club head adjacent to the golf ball,
wherein the impact section data includes image data at a moment when the club head passes in front of the golf ball,
wherein the calculation unit calculates the ball flight information based on the center coordinate information of the club head and club head angle information formed by a face surface of the club head and a ground on which the golf ball is placed,
wherein the second image data obtained from the second camera has higher resolution than the first image data obtained from the first camera,
wherein the image analysis unit identifies the first coordinate information based on the first image data,
wherein the image analysis unit extracts partial image data corresponding to the club head from the second image data based on the first coordinate information, and
wherein the calculation unit identifies the club head angle information based on the extracted partial image data.

2. The apparatus of claim 1, wherein the image analysis unit is configured to:
generate merged image data based on an image data set obtained from the first camera; and
identify the first coordinate information based on the merged image data.

3. The apparatus of claim 2, wherein the calculation unit is configured to:
identify the impact section data based on the merged image data;
extract a part of the second image data as partial image data so as to correspond to the impact section data; and
identify the ball flight information based on the partial image data.

4. The apparatus of claim 1, wherein the calculation unit is configured to:
derive a predicted flight speed, a predicted direction, and a side spin of the golf ball based on an orbit in which the club head relatively passes relative to the golf ball by the practice swing of the user, an edge angle of the club head, and a speed at which the club head passes.

5. The apparatus of claim 4, wherein the calculation unit is configured to:
calculate the ball flight information based on the predicted flight speed, the predicted direction, and the side spin of the golf ball, which are derived.

6. The apparatus of claim 1, wherein the ball flight information is identified based on machine learning.

7. The apparatus of claim 1, further comprising:
a gyroscope sensor configured to sense angle information about the ground of the user,
wherein the calculation unit calculates the ball flight information by reflecting a slope relative to the ground of the user based on the angle information obtained from the gyroscope sensor.

8. A golf swing analysis system, the system comprising:
a golf swing analysis apparatus configured to identify ball flight information about a practice swing of a user;
a server configured to obtain first image data, first coordinate information, impact section data, and ball flight information from the golf swing analysis apparatus, and to generate image data based on the first image data, the first coordinate information, the impact section data, and the ball flight information; and
a user terminal configured to output the image data obtained from the server,
wherein the golf swing analysis apparatus includes:
an input unit including a first camera and a second camera;
an image analysis unit configured to identify first coordinate information corresponding to first image data obtained from the first camera;
a calculation unit configured to identify impact section data based on the first coordinate information; and
an output unit configured to externally output ball flight information calculated by the calculation unit,
wherein the image analysis unit transmits, to the calculation unit, second image data obtained from the second camera corresponding to the impact section data,
wherein the calculation unit calculates ball flight information about the practice swing of the user based on the impact section data and the second image data,
wherein the first coordinate information includes center coordinate information of a golf ball, radius information of the golf ball, and center coordinate information of a club head adjacent to the golf ball,
wherein the impact section data includes image data at a moment when the club head passes in front of the golf ball,
wherein the calculation unit calculates the ball flight information based on the center coordinate information of the club head and club head angle information formed by a face surface of the club head and a ground on which the golf ball is placed,
wherein the second image data obtained from the second camera has higher resolution than the first image data obtained from the first camera,
wherein the image analysis unit identifies the first coordinate information based on the first image data,
wherein the image analysis unit extracts partial image data corresponding to the club head from the second image data based on the first coordinate information, and
wherein the calculation unit identifies the club head angle information based on the extracted partial image data.

9. A method performed by a golf swing analysis apparatus, the method comprising:
obtaining first image data from a first camera of the golf swing analysis apparatus;
obtaining second image data from a second camera of the golf swing analysis apparatus;
identifying first coordinate information corresponding to the first image data;
identifying impact section data based on the first coordinate information;
obtaining the second image data corresponding to the impact section data;
calculating ball flight information about a practice swing of a user based on the impact section data and the second image data; and
externally outputting the ball flight information,
wherein the first coordinate information includes center coordinate information of a golf ball, radius information of the golf ball, and center coordinate information of a club head adjacent to the golf ball,
wherein the impact section data includes image data at a moment when the club head passes in front of the golf ball,
wherein the golf swing analysis apparatus calculates the ball flight information based on the center coordinate information of the club head and club head angle information formed by a face surface of the club head and a ground on which the golf ball is placed,
wherein the second image data obtained from the second camera has higher resolution than the first image data obtained from the first camera, and
wherein the golf swing analysis apparatus is configured to:
identify the first coordinate information based on the first image data;
extract partial image data corresponding to the club head from the second image data based on the first coordinate information; and
identify the club head angle information based on the extracted partial image data.

10. A computer-readable recording medium storing a program for executing the golf swing analysis method of claim 9 in combination with a computer.
